(19) United States
(12) Patent Application Publication
(10) Pub. No.: US 2006/0264326 A1
(43) Pub. Date: Nov. 23, 2006

(54) Heat-sensitive record material

(75) Inventors: Mark Robert Fisher, Appleton, WI (US); Stacey Ann Justa MacNeil, Appleton, WI (US); Rachelle Marie Vervacke-Rauen, Appleton, WI (US)

Correspondence Address: APPLETON PAPERS INC.;LAW DEPARTMENT, 825 E. WISCONSIN AVENUE, PO BOX 359, APPLETON, WI, 54912-0359, US

(73) Assignee: Appleton Papers Inc., Appleton, WI (US)

(21) Appl. No.: 11/432,582

(22) Filed: May 11, 2006

Related U.S. Application Data
(60) Provisional application No. 60/682,003, filed on May 17, 2005.

(51) Int. Cl. B41M 5/24

(52) U.S. Cl. 503/201

(57) ABSTRACT

The invention describes an improved heat-sensitive recording material comprising a substrate having coated thereon a thermally-sensitive color-forming composition in one or more layers. The thermally sensitive color forming composition comprises a chromgenic dye precursor, an acidic developer material and a first binder material, and at least one protective layer comprising a dimer form of benzotriazole, namely, 2,2′-methylenebis(6-(2H-benzotriazol-2-yl)-4-(1,1,3,3-tetramethylbutyl)phenol) dispersed in a second binder material, wherein the first binder material and the second binder material can be the same or different. Preferably 2,2′-methylenebis(6-(2H-benzotriazol-2-yl)-4-(1,1,3,3-tetramethylbutyl)phenol) is dispersed in both the protective layer and the thermally sensitive color forming layer or layers. The thermally sensitive record material is remarkably resistant to scuffing, has a high degree of background whiteness, is resistant to printhead dusting and is remarkably resistant to fade as compared to other systems with other UV absorbers. The dimer form surprisingly contributes to a significant increase in coating hardness, reduced scuffing, reduced printhead contamination and dramatically increased resistance to fade as compared to the benzotriazoles taught in the art for record material applications.

This application under 35 U.S.C. § 111(a) claims priority to provisional U.S. application Ser. No. 60/682,003 filed May 17, 2005 and incorporated herein by reference.

### FIELD OF THE INVENTION

1. Background of the Invention

This invention relates to heat-sensitive or thermally-responsive record material. It more particularly relates to such record material in the form of sheets coated with color-forming systems comprising chromogenic material, and acidic color developer. This invention particularly concerns a thermally-responsive record material having UV resistance, high background whiteness, improved scuff resistance, reduced printhead contamination, and surprising coating hardness.

2. Description of Related Art

Thermally-responsive record material systems are well known in the art and are described in many patents, for example, U.S. Pat. Nos. 3,539,375; 3,674,535; 3,746,675; 4,151,748; 4,181,771; 4,246,318; and 4,470,057 which are incorporated herein by reference. In these systems, basic chromogenic material and acidic color developer material are contained in a coating on a substrate which, when heated to a suitable temperature, melts, sublimes or softens to permit said materials to react, thereby producing a colored mark.

Thermally-responsive record materials have characteristic thermal responses, desirably producing a detectable image of certain intensity upon thermal exposure which can be in a selective pattern to record into the record material various characters, images, patterns or other information.

A drawback of thermally-responsive record materials limiting utilization in certain environments has been the tendency of thermally imaged materials to fade or discolor upon prolonged exposure to sunlight, especially attributable to UV degradation of the image.

Attempts have been made to address the issues of UV degradation by proposing use of various UV blockers and absorbers. Although many UV blocking and absorbing materials are known, they have limitations in terms of degree of functionality, and dusting or softness of the coating dispersions. Among the known UV resistant layer ultraviolet absorbers are benzotriazole type, benzophenone type, salicylic acid type, a hydroquinone type and hindered amine types of ultraviolet absorbers. The ultraviolet resistant layer is typically in the form of a coated coatable fluid dispersion of UV absorber and binder, applied as a separate layer or as a top coating protective layer over a heat sensitive layer. Optionally a fluorescent material can be included in the UV resistant layer that converts long wavelength ultraviolet into longer wavelength blue light to increase the ultraviolet absorbing efficiency. Typical UV absorbers include: benzophenone type such as 2-hydroxy-4-n-octoxybenzophenone; 2-hydroxy-4-methoxy-2′-carboxybenzophenone; 2,4-dihydroxybenzophenone; 2,2′-dihydroxy-4,4′-dimethoxy-benzophenone such as Uvinul D-49 (a product of BASF); 2-hydroxy-4-benzoyloxybenzophenone; 2,2′-dihydroxy-4-methoxy-benzophenone; 2-hydroxy-4-methoxy-5-sulfonebenzophenone; 2,2′,4,4′-tetrahydroxybenzophenone; 2,2′-dihydroxy-4,4′-dimethoxy-5-sodium sulfonebenzophenone; 4-dodecyloxy-2-hydroxy-benzophenone; and 2-hydroxy-5-chlorobenzophenone and the like. Examples of a benzotriazole type are 2-(5′-methyl-2′-hydroxyphenyl)benzotriazole such as Tinuvin P (a product of Ciba-Geigy); 2-(2′-hydroxy-5′-tert-butylphenyl)-benzotriazole such as Tinuvin PS (a product of Ciba-Geigy); 2-[2′-hydroxy-3′,5′-bis a,a-dimethylbenzyl)-phenyl]-2H-benzotriazole such as Tinuvin 234 (a product of Ciba-Geigy); 2-(3′,5′-di-tert-butyl-2′-hydroxyphenyl)-benzotriazole such as Tinuvin 320 (a product of Ciba-Geigy); 2-(3′-tert-butyl-5′-methyl-2′-hydroxyphenyl)-5-chlorobenzotriazole such as Tinuvin 326 (a product of Ciba-Geigy); 2-(3′,5′-di-tert-butyl-2′-hydroxyphenyl)-5-chlorobenzotriazole such as Tinuvin 327 (a product of Ciba-Geigy); 2-(3′,5′-di-tert-amyl-2′-hydroxyphenyl)-triazole such as Tinuvin 328 (a product of Ciba-Geigy); 5-tert-butyl-3-(5-chloro-2H-benzotriazol-2-yl)-4-hydroxybenzenepropionic acid octyl ester such as Tinuvin 109 (a product of Ciba-Geigy); and 2-(2′-hydroxy-3,5-di-(1,1′-dimethylbenzyl)phenyl)-2H-benzotriazole such as Tinuvin 900 (a product of Ciba-Geigy).

Examples of salicylic acid type of UV absorbers are phenyl salicylate such as Seesorb 201 (a product of Shiraishi Calcium); p-tert-butyl salicylate such as Sumisorb 90 (a product of Sumitomo Chemical); and p-octylphenyl salicylate (a product of Eastman Chemical) and the like. Examples of a hydroquinone type are hydroquinone and hydroquinone salicylate and the like.

Although many UV absorbers are known, a need exists for an improved heat sensitive recording systems with a UV absorber. Heat sensitive systems using typical benzotriazole compounds when imaged exhibit premature fade and background discoloration tending toward yellow. Background discoloration gives rise to poor contrast and an undesirable offwhite appearance of the sheet. Problems associated with many UV absorbers include background discoloration, degradation of surface durability, delamination, softness, background fog, and printhead contamination.

A need has continued to identify heat sensitive record material systems which when thermally imaged have resistance to scuffing, yet have a high degree of background whiteness, have high contrast and low background discoloration, are resistant to thermal printhead dusting, and are dramatically improved in terms of resistance to image fading when subjected to ultraviolet light. Such heat sensitive systems would be an advance in the art and of commercial significance.

### SUMMARY OF THE INVENTION

The invention describes a heat-sensitive recording material comprising a substrate having coated thereon a thermally-sensitive color-forming composition in one or more layers, the thermally sensitive color forming composition comprising a chromogenic dye precursor, an acidic developer material and a first binder material. The heat sensitive recording material includes at least one protective overcoat layer comprising a dimer form of benzotriazole with unique characteristics, namely, 2,2′-methylenebis(6-(2H-benzotriazol-2-yl)-4-(1,1,3,3-tetramethylbutyl)phenol), CAS Reg. No. [103597-45-1], dispersed in a second binder material. The first binder material and the second binder material can be the same or different.

In one embodiment of the heat sensitive recording material the 2,2′-methylenebis(6-(2H-benzotriazol-2-yl)-4-(1,1,3,3-tetramethylbutyl)phenol) can be selected to be from 0.1 to 75 weight percent based on weight of the protective layer when separately overcoated, or based on weight of the thermally-sensitive color forming composition if blended into the color forming layer. Alternatively 0.1 to 40 weight percent of the dimer may be employed.

In another alternate embodiment of the heat sensitive recording material, the thermally sensitive color forming composition can include in addition bis(3-allyl-4-hydroxyphenyl)sulfone. Bis(3-allyl-4-hydroxyphenyl)sulfone preferably is at from 0.1 weight percent to 80 weight percent based on weight of the thermally sensitive color forming composition, and most preferably 5 to 75 weight percent, based on weight of the thermally sensitive color forming composition.

Optionally, the thermally sensitive color forming composition can include in addition a sensitizer. The sensitizer is preferably selected from 1,2-diphenoxyethane, acetoacet-o-toluidine, dimethyl terephthalate, p-benzylbiphenyl, and phenyl-1-hydroxy-2-naphthoate.

In a preferred embodiment of the heat sensitive recording material, the 2,2′-methylenebis(6-(2H-benzotriazol-2-yl)-4-(1,1,3,3-tetramethylbutyl)phenol) is dispersed in a polymeric binder coated over the layer of thermally sensitive color forming composition.

In yet another embodiment, the 2,2′-methylenebis(6-(2H-benzotriazol-2-yl)-4-(1,1,3,3-tetramethylbutyl)phenol) bis[2-hydroxy-5-t-octyl-3-(benzotriazol-2-yl)phenyl]methane in addition is an additive in the thermally sensitive color forming composition layer or layers.

Preferably the polymeric binder is selected from polyvinyl alcohol, polyvinyl acetate and polyacrylate.

The protective layer of 2,2′-methylenebis(6-(2H-benzotriazol-2-yl)-4-(1,1,3,3-tetramethylbutyl)phenol) dispersed in polymeric binder has a hardness increase of at least 0.02 GPa. Increase is measured relative to a polymerized coating without 2,2′-methylenebis(6-(2H-benzotriazol-2-yl)-4-(1,1,3,3-tetramethylbutyl)phenol).

The protective layer of 2,2′-methylenebis(6-(2H-benzotriazol-2-yl)-4-(1,1,3,3-tetramethylbutyl)phenol) dispersed in polymeric binder for example of polyvinyl alcohol has a surprising improvement in numerous properties sought in thermally imaging materials. The invention teaches a thermally imaging system with a measurable increase in durability or hardness with various polymeric binders as compared to record materials using non-dimer forms of benzotriazole, or in certain instances as compared to the polymeric binders alone. Durability is reflected in improved elastic modulus values as compared to other UV absorbers.

### DETAILED DESCRIPTION

The present invention is an improved thermally-responsive record material having an intense image of high contrast on a white background. The thermally responsive record materials of the invention are resistant to scuffing, yet have a high degree of background whiteness, have high contrast and low background discoloration, are resistant to thermal printhead dusting, and are dramatically improved in terms of resistance to image fading when subjected to ultraviolet light.

The invention describes a heat-sensitive recording material comprising a substrate having coated thereon a thermally-sensitive color-forming composition in one or more layers, the thermally sensitive color forming composition comprising a chromogenic dye precursor, an acidic developer material and a first binder material. The heat sensitive recording material includes at least one protective overcoat layer comprising 2,2′-methylenebis(6-(2H-benzotriazol-2-yl)-4-(1,1,3,3-tetramethylbutyl)phenol) dispersed in a second binder material. The first binder material and the second binder material can be the same or different.

2,2′-methylenebis(6-(2H-benzotriazol-2-yl)-4-(1,1,3,3-tetramethylbutyl)phenol) having the following structure is preferably employed.

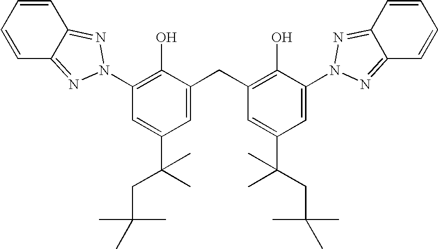

Although many benzotriazole compounds are known, to date their effectiveness has been limited by inability to preclude fade or discoloration over extended periods of time. Use of UV additives in thermally imaging systems has been further limited since such materials can degrade hardness and durability characteristics of the protective layer, can degrade scuff resistance, promote background fogging, can lead to printhead contamination and difficulties in coating adherence. UV additives contribute to dusting and softness of the coating dispersions impairing durability. The present invention surprisingly has found that a dimer form of benzotriazole imparts to recording materials properties not previously seen with use of other benzotriazoles.

The dimer form of benzotraizole has not been previously applied to coatings for papers and recording materials due to handling and rheology constraints associated with high molecular weight materials. The dimer form of benzotriazole used in the invention surprisingly contributed to a significant increase in coating hardness, reduced scuffing, reduced printhead contamination along with dramatically increased resistance to fade or discoloration as compared to the benzotriazoles taught in the art for record material applications.

In one embodiment of the heat sensitive recording material the 2,2′-methylenebis(6-(2H-benzotriazol-2-yl)-4-(1,1,3,3-tetramethylbutyl)phenol) can be selected to be 0.01 to 80 weight percent, and more preferably from 0.1 to 75 and most preferably from 0.1 to 40 weight percent based on weight of the protective layer composition.

In an alternate embodiment of the heat sensitive recording material, the thermally sensitive color forming composition can include in addition bis(3-allyl-4-hydroxyphenyl)sulfone. Bis(3-allyl-4-hydroxyphenyl)sulfone preferably is at 0.1 to 80 weight percent and more preferably from 5 weight percent to 75 weight percent, and most preferably 5 to 25 weight percent, based on weight of the thermally sensitive color forming composition.

Optionally, the thermally sensitive color forming composition can include in addition a sensitizer.

The sensitizer is preferably selected from 1,2-diphenoxyethane, acetoacet-o-toluidine, dimethyl terephthalate, p-benzylbiphenyl, and phenyl-1-hydroxy-2-naphthoate.

In a preferred embodiment of the heat sensitive recording material, the 2,2′-methylenebis(6-(2H-benzotriazol-2-yl)-4-(1,1,3,3-tetramethylbutyl)phenol) is dispersed in a polymeric binder coated over the layer of thermally sensitive color forming composition.

In yet another embodiment, the 2,2′-methylenebis(6-(2H-benzotriazol-2-yl)-4-(1,1,3,3-tetramethylbutyl)phenol) in addition is an additive in the thermally sensitive color forming composition layer or layers.

The protective layer of 2,2′-methylenebis(6-(2H-benzotriazol-2-yl)-4-(1,1,3,3-tetramethylbutyl)phenol) dispersed in polymeric binder, for example polyvinyl alcohol, has a hardness increase of at least 0.02 GPa as compared to use of other benzotriazoles. A protective layer of 2,2′-methylenebis(6-(2H-benzotriazol-2-yl)-4-(1,1,3,3-tetramethylbutyl)phenol) dispersed in polymeric binder has a significant increase in hardness.

Thermally-responsive or heat-sensitive recording materials bear a thermally-sensitive color-forming composition comprising a chromogenic material and an acidic developer material in substantially contiguous relationship, whereby the melting, softening or sublimation of either material produces a color, in other words a change-in-color reaction.

A sensitizer (also known as a modifier) such as a 1,2-diphenoxyethane is preferably included. Such material typically does not impart any image on its own and is not considered active in the formation of color but as a relatively low melting solid acts as a solvent to facilitate reaction between the mark-forming components. Other such sensitizers are described in U.S. Pat. No. 4,531,140. Other sensitizers for example can include N-acetoacetyl-o-toluidine, phenyl-1-hydroxy-2-naphthoate, dibenzyloxalate, and para-benzylbiphenyl by way of illustration and without limitation.

The color-forming composition (or system) of the record material of this invention comprises chromogenic material in its substantially colorless state and acidic developer material dispersed in a binder material. The color-forming system typically relies upon melting, softening, or subliming one or more of the components to achieve reactive, color-producing contact.

The record material includes a substrate or support material which is generally in sheet form. For purposes of this invention, sheets can be referred to as substrates or support members and are understood to also mean webs, ribbons, tapes, belts, films, labels, cards and the like. Sheets denote articles having two large surface dimensions and a comparatively small thickness dimension. The substrate or support material can be opaque, transparent or translucent and could, itself, be colored or not. The material can be fibrous including, for example, paper and filamentous synthetic materials. It can be a film including, for example, cellophane and synthetic polymeric sheets cast, extruded, or otherwise formed. Invention resides in the color-forming composition coated on the substrate. The kind or type of substrate material is not critical.

The components of the color-forming system are in a proximate relationship meaning, a substantially contiguous or near contiguous relationship, substantially homogeneously distributed throughout the coated layer material deposited on the substrate in one or more layers. In manufacturing the record material, a coating composition is prepared which includes a fine dispersion of the components of the color-forming system, binder material typically a polymeric material, surface active agents and other additives in an aqueous coating medium. As will be readily evident to the skilled artisan, the reactive components can be dispersed and coated in the same layer or in separate layers. For example the chromogenic materials can be in one layer and the developer materials optionally in the same layer or in separate layers above or below the layer with chromogenic material. A protective overcoat layer such as polyvinylalcohol or its derivatives or other binder materials can be optionally utilized for such purpose. Optionally any of the layer or layers can be spot printed for specialized applications. Most commonly, the entire sheet is coated. The composition can additionally contain inert pigments, such as clay, talc, aluminum hydroxide, calcined kaolin clay and calcium carbonate; synthetic pigments, such as urea-formaldehyde resin pigments; natural waxes such as Carnauba wax; synthetic waxes; lubricants such as zinc stearate; wetting agents; defoamers, and antioxidants.

The color-forming system components are substantially insoluble in the dispersing vehicle (preferably water) and are ground to an individual average particle size of from less than 1 micron to less than about 10 microns, preferably less than about 3 microns. A binder can be included. The binder can be a polymeric material and is substantially vehicle soluble although latexes are also eligible in some instances. Preferred water soluble binders include polyvinyl alcohol, hydroxy ethylcellulose, methylcellulose, methyl-hydroxypropylcellulose, starch, styrene maleic anhydride salts, modified starches, gelatin and the like. Eligible latex materials include polyacrylates, styrene-butadiene-rubber latexes, polyvinylacetates, polystyrene, and the like. The polymeric binder is used to protect the coated materials from brushing and handling forces occasioned by storage and use of thermal sheet. Binder should be present in an amount to afford such protection and in an amount less than will interfere with achieving reactive contact between color-forming reactive materials. Polymeric binders such as polyvinyl alcohol, polyvinyl acetate, and polyacrylate can be conveniently employed as the protective layer coated over the thermally imaging layer or layers.

Coating weights can effectively be about 1 to 12 grams per square meter (gsm), more preferably from 3 to about 9 grams per square meter (gsm) and usefully about 5 to about 6 gsm. The practical amount of coating or color-forming materials is controlled by economic considerations, functional parameters and desired handling characteristics of the coated sheets.

The chromogens could include any of the conventional chromogens such as the phthalide, leucoauramine and fluoran compounds. Other examples of chromogen compounds include Crystal Violet Lactone (3,3-bis(4-dimethylaminophenyl)-6-dimethylaminophthalide, U.S. Pat. No. Re. 23,024); phenyl-, indolyl, pyrrolyl, and carbazolyl substituted phthalides (for example, in U.S. Pat. Nos. 3,491,111; 3,491,112; 3,491,116; 3,509,174); nitro-, amino-, amido-, sulfonamido-, aminobenzylidene-, halo-, anilino-substituted fluorans (for example, in U.S. Pat. Nos. 3,624,107; 3,627,787; 3,641,011; 3,642,828; 3,681,390); spirodipyrans (U.S. Pat. No. 3,971,808); and pyridine and pyrazine compounds (for example, in U.S. Pat. Nos. 3,775,424 and 3,853,869).

Other eligible chromogenic compounds include 3-diethylamino-6-methyl-7-anilino-fluoran (U.S. Pat. No. 3,681,390); 2-anilino-3-methyl-6-dibutylamino-fluoran (U.S. Pat. No. 4,510,513) also known as 3-di-n-butylamino-6-methyl-7-anilino-fluoran; 3-di-n-butylamino-7-(2-chloroanilino)fluoran; 3-(N-ethyl-N-tetrahydrofurfurylamino)-6-methyl-7-3,5′6-tris(dimethylamino)spiro[9H-fluorene-9,1′(3′H)-isobenzofuran]3′-one; 7-(1-ethyl-2-methylindole-3-yl)-7-(4-diethyl-amino-2-ethoxyphenyl)-5,7-dihydrofuro[3,4-b]pyridin-5-one (U.S. Pat. No. 4,246,318); 3-diethylamino-7-(2-chloroanilino)fluoran (U.S. Pat. No. 3,920,510); 3-(N-methylcyclohexylamino)-6-methyl-7-anilinofluoran (U.S. Pat. No. 3,959,571); 7-(1-octyl-2-methylindole-3-yl)-7-(4-diethyl-amino-2-ethoxyphenyl)-5,7-dihydrofuro[3,4-b]pyridin-5-one; 3-diethylamino-7,8-benzofluoran; 3,3-bis (1-ethyl-2-methylindole-3-yl)phthalide; 3-diethylamino-7-anilinofluoran; 3-diethylamino-7-benzylaminofluoran; 3′-phenyl-7-dibenzylamino-2,2′-spirodi-[2H-1-benzopyran] and mixtures of any of the above.

Examples of eligible acidic (or electron accepting) color-developer material include the compounds listed in U.S. Pat. No. 3,539,375 as phenolic reactive material, particularly the monophenols and diphenols. Eligible acidic developer material also includes, without being considered as limiting, the following compounds which may be used individually or in mixtures: 4,4′-isopropylidine-diphenol (Bisphenol A); p-hydroxybenzaldehyde; p-hydroxybenzophenone; p-hydroxypropiophenone; 2,4-dihydroxybenzophenone; 1,1-bis(4-hydroxyphenyl)cyclohexane; salicylanilide; 4-hydroxy-2-methylacetophenone; 2-acetylbenzoic acid; m-hydroxyacetanilide; p-hydroxyacetanilide; 2,4-dihydroxyacetophenone; 4-hydroxy-4′-methylbenzophenone; 4,4′-dihydroxybenzophenone; bis(3-allyl-4-hydroxyphenyl) sulfone, 2,2-bis(4-hydroxyphenyl)-4-methylpentane; benzyl-4-hydroxyphenyl ketone; 2,2-bis(4-hydroxyphenyl)-5-methylhexane; ethyl-4,4-bis(4-hydroxyphenyl)-pentanoate; isopropyl-4,4-bis(4-hydroxyphenyl)pentanoate; methyl-4,4-bis(4-hydroxyphenyl)pentanoate; allyl-4,4-bis(4-hydroxyphenyl)pentanoate; 3,3-bis(4-hydroxyphenyl)-pentane; 4,4-bis(4-hydroxyphenyl)heptane; 2,2-bis(4-hydroxyphenyl)-1-phenylpropane; 2,2-bis(4-hydroxyphenyl)butane; 2,2′-methylene-bis(4-ethyl-6-tertiarybutylphenol); 4-hydroxycoumarin; 7-hydroxy-4-methylcoumarin; 2,2′-methylene-bis(4-octylphenol); 4,4′-sulfonyldiphenol; 4,4′-thiobis(6-tertiarybutyl-m-cresol); methyl-p-hydroxybenzoate; n-propyl-p-hydroxybenzoate; benzyl-p-hydroxybenzoate; 4-(4-(1-methylethoxy)phenyl) sulphonyl phenol. Preferred among these are the phenolic developer compounds. More preferred among the phenol compounds are 4,4′-isopropylidinediphenol, ethyl-4,4-bis(4hydroxyphenyl)pentanoate, n-propyl-4,4-bis(4-hydroxyphenyl) pentanoate, isopropyl-4,4-bis(4-hydroxyphenyl)pentanoate, methyl-4,4-bis(4-hydroxyphenyl)pentanoate, 2,2-bis(4-hydroxyphenyl)-4-methylpentane, p-hydroxybenzophenone, 2,4-dihydroxybenzophenone, 1,1-bis(4-hydroxyphenyl)cyclohexane, and benzyl-p-hydroxybenzoate; 4-(4-(1-methylethoxy)phenyl)sulphonyl phenol and 4,4′-[1,3-phenylenebis(1-methylethylene)]bisphenol. Acidic compounds of other kind and types are eligible. Examples of such other acidic developer compounds are phenolic novolak resins which are the product of reaction between, for example, formaldehyde and a phenol such as an alkylphenol, e.g., p-octylphenol, or other phenols such as p-phenylphenol, and the like; and acid mineral materials including colloidal silica, kaolin, bentonite, attapulgite, hallosyte, and the like. Some of the polymers and minerals do not melt but undergo color reaction on fusion of the chromogen. Of the foregoing particularly the phenol type of compounds are more preferable acidic developer materials.

The following examples are given to illustrate some of the features of the present invention and should not be considered as limiting. In these examples all parts or proportions are by weight and all measurements are in the metric system, unless otherwise stated.

In all examples illustrating the present invention a dispersion of a particular system component was prepared by milling the component in an aqueous solution of the binder until a particle size of less than about 1 micron to less than about 10 microns was achieved. The desired average particle size was less than 3 microns in each dispersion.

In practice the coatings or one or more coating layers can be applied to a substrate by any known coating technique including rod coating, blade coating, slot die, curtain or curtains, air knife, casting drum, gravure, reverse roll coating, bead coating, extrusion, spraying, spot printing, blade coating, and other coating methods known in the art.

The thermally-responsive sheets were made by making separate dispersions of chromogenic material and acidic material. The dispersions were mixed in the desired ratios and applied to a support with a wire wound rod and dried. Other non-active (as that term is understood in this application) materials such as modifiers, fillers, antioxidants, lubricants and waxes can be added if desired. The sheets may be calendered to improve smoothness. The dispersions were prepared in a small media mill.

### EXAMPLES

In the examples unless otherwise indicated coatings are applied at 6.7 g/m². A topcoat is applied @ 3.5 g/m². Printing can be accomplished on an Atlantek 400 Dynamic Response Printer. Whiteness was measured using a Technidyne Color Touch 2-Model ISO and Print density was measured using a GretagMacbeth D19C.

Increase in hardness and Elastic Modulus is measurable using an MTS Nanoindenter XP. This instrument performs indentation tests by driving a diamond stylus into a specimen surface and dynamically collecting the applied force and displacement data. The indenter is driven to a depth of 200 nm using the “XP CSM Standard Hardness, Modulus and Tip Cal” method. Details of the instrument and testing technique are more fully described in an article by Oliver and Pharr in Journal of Materials Research, Vol 7, No. 6, June 1992, pp. 1564-1583.

Wet Rub:

A test sample is soaked in water for ten minutes. The sample is placed on a glass surface and rubbed using a rough cloth in a unidirectional cross directional motion (left to right only) until failure. Failure is defined as “the appearance of a milky white coloration to the surface of the glass.” Example 1 was used as the control. A “−” value indicates a change at less rubs than the control. A “+” indicates results better than the control. A “++” indicates results substantially better than the control.

Hazing:

Samples were imaged on the Zebra printer (Zebra 140xi III) at 4 inches per second with a block and barcode pattern. Samples are placed in a 50° C. oven for 24 hours to induce cure. After 24 hours the imaged block of samples are read with a Gretag densitometer. A portion of the block is wiped with a cotton swab and that area is read using the same densitometer. The delta, change from initial reading, is calculated and reported. Delta values between 6 and 15 are considered worse then the control, delta values above 16 are considered much worse than the control.

Whiteness:

Samples are exposed in a QUV chamber (QUV Accelerated Weather Tester; Model: QUV/spray from Q-Lab) for 4 hours (at 50° C.; irradiance set point 0.55; UVA340 bulbs). Samples were read on a Color Touch 2 Model ISO (Technidyne). The change in b* value, Δb* is reported and is an indication of the degree of thermal paper yellowing.

The CIE improvement of the Hunter L, a, b Color Space can be used for measuring whiteness. Starlab or CIELAB modified the Hunter L, a, b Color Space chart to report L*, a*, b* ΔE* values. Supplement No. 2 to CIE Publication No. 15, “Colorimetry.” Hunter Associates Laboratory Inc., 11491 Sunset Hills Road, Reston, Va. 20190. See also ASTM E308-01. Δb* values are overall color difference which take into account lightness/darkness as well as chromatic differences. Δb* values measure the tendency toward yellow. Positive values tend to yellow. Negative values tend toward blue. The L, a, b color system is described in “A Prismatic Display of Measured Color Difference, National Coil Coaters Association, 4011 N. Michigan Avenue, Chicago, Ill. 60611.

Printhead Contamination:

Samples are imaged on a Zebra printer (Zebra 140xi III) at 4 inches per second with a block and barcode pattern for 1000 prints. Printhead is inspected at 500 and 1000 prints.

### EXAMPLES

| | Parts by weight |
|---|---|
| Dispersion A - Chromogenic Material | |
| Chromogenic Material | 32 |
| Binder, 20% solution PVOH in water | 27 |
| Defoaming and dispersing agents | 0.5 |
| Water | 40.5 |
| Dispersion A1 - Chromogenic Material is ETAC | |
| Spiro[isobenzofuran-1(3H),9′-[9H]xanthen]-3-one,6′- | |
| [ethyl(4-methylphenyl)amino] | |
| Dispersion B - Acidic Material | |
| Acidic Material | 40 |
| Binder, 20% solution PVOH in water | 22 |
| Defoaming and dispersing agents | 0.5 |
| Water | 37.5 |
| Dispersion B1 - Acidic Material is TGSA | |
| Bis(Hydroxyphenyl)sulfone | |
| Dispersion C - Sensitizing Material | |
| Sensitizing Material | 38 |
| Binder, 20% solution PVOH in water | 30 |
| Defoaming and dispersing agents | 0.5 |
| Water | 31.5 |
| Dispersion C1 - Sensitizing Material DPE | |
| 1,2-Diphenoxyethane | |
| Dispersion D - Additive Material | |
| Additive Material | 32 |
| Binder, 20% solution PVOH in water | 27 |
| Defoaming and dispersing agents | 0.5 |
| Water | 40.5 |

Dispersion D1 - Additive Material is Dimer
2,2′-methylenebis(6-(2H-benzotriazol-2-yl)-
4-(1,1,3,3-tetramethylbutyl)phenol)
Dispersion D2 - Additive Meterial is Ciba Tinuvin 234
2-(2H-Benzotriazol-2-yl)-6-(1-methyl-1-phenylethyl)-
4-(1,1,3,3-tertramethylbutyl)phenol
Dispersion D3 - Additive Material is Tinuvin 328
2-(2H-Benzotriazol-2-yl)-4,6-di-tert-pentylphenol
Dispersion D4 - Additive Material is Tinuvin 327
2,4-Di-tertbutyl-6-(5-chlorobentzotriazol-2-yl)phenol

| | Parts |
|---|---|
| Active Coating Formulation 1 | |
| Dispersion A (Chromogenic Material) | 22 |
| Dispersion B (Acidic Material) | 37 |
| Dispersion C (Sensitizing Material) | 23 |
| Binder, 10% solution of PVOH in water | 5 |
| Latex | 6 |
| Water | 7 |
| Active Coating Formulation 2 | |
| Dispersion A (Chromogenic Material) | 23 |
| Dispersion B (Acidic Material) | 40 |
| Dispersion C (Sensitizing Material) | 13 |
| Dispersion D (Additive Material) | 5 |
| Binder, 10% solution of PVOH in water | 5 |
| Latex | 6 |
| Water | 8 |
| Protective Coating Formulation 1 | |
| Delaminated Kaolin clay, 60% in water | 24 |
| Amorphous silicon dioxide, 20% in water | 7 |
| Binder, 20% solution PVOH in water | 44 |
| Zinc stearate, 32% water emulsion | 3 |
| Polyamide-epichlorohydrin crosslinker, water based | 22 |
| Protective Coating Formulation 2 | |
| Delaminated Kaolin clay, 60% in water | 24 |
| Amorphous silicon dioxide, 20% in water | 7 |
| Binder, 20% solution PVOH in water | 44 |
| Zinc stearate, 32% water emulsion | 3 |
| Polyamide-epichlorohydrin crosslinker, water based | 22 |
| Dispersion D (Additive Material) | 7.5 |

Protective Coating Formulation 2A uses
Dispersion D1 (Dimer)
Protective Coating Formulation 2B uses
Dispersion D2 (Tinuvin 928)
Protective Coating Formulation 2C uses
Dispersion D3 (Tinuvin 328)
Protective Coating Formulation 2D uses
Dispersion D4 (Tinuvin 327)

### Example 1

### Control

Active Coating Formulation 1 using
Dispersion A1 (ETAC)
Dispersion B1 (TGSA)
Dispersion C1 (DPE)

Protective Coating Formulation 1

### Example 2

Active Coating Formulation 1 using
Dispersion A1 (ETAC)
Dispersion B1 (TGSA)
Dispersion C1 (DPE)

Protective Coating Formulation 2A

### Example 3

Active Coating Formulation 1 using
Dispersion A1 (ETAC)
Dispersion B1 (TGSA)
Dispersion C1 (DPE)

Protective Coating Formulation 2B

### Example 4

Active Coating Formulation 1 using
Dispersion A1 (ETAC)
Dispersion B1 (TGSA)
Dispersion C1 (DPE)

Protective Coating Formulation 2C

### Example 5

Active Coating Formulation 1 using
Dispersion A1 (ETAC)
Dispersion B1 (TGSA)
Dispersion C1 (DPE)

Protective Coating Formulation 2D

### Example 6

Active Coating Formulation 2 using
Dispersion A1 (ETAC)
Dispersion B1 (TGSA)
Dispersion C1 (DPE)
Dispersion D1 (Dimer)

Protective Coating Formulation 2A

### Example 7

Active Coating Formulation 2 using
Dispersion A1 (ETAC)
Dispersion B1 (TGSA)
Dispersion C1 (DPE)
Dispersion D2 (Tinuvin 928)

Protective Coating Formulation 2B

### Example 8

Active Coating Formulation 2 using
Dispersion A1 (ETAC)
Dispersion B1 (TGSA)
Dispersion C1 (DPE)
Dispersion D3 (Tinuvin 328)

Protective Coating Formulation 2C

### Example 9

Active Coating Formulation 2 using
Dispersion A1 (ETAC)
Dispersion B1 (TGSA)
Dispersion C1 (DPE)
Dispersion D4 (Tinuvin 327)

Protective Coating Formulation 2D

### Example 10

Active Coating Formulation using
Dispersion A1 (ETAC)
Dispersion B1 (TGSA)
Dispersion C1 (DPE)

Protective Coating Formulation 2I

### Example 11

Active Coating Formulation using
Dispersion A1 (ETAC)
Dispersion B1 (TGSA)
Dispersion C1 (DPE)

Protective Coating Formulation 2J

| | Printhead | | | Whiteness^{#} (Δb* | Nano- Indentation |
|---|---|---|---|---|---|
| | Contamination* | Fogging** | Wet Rub*** | value UV ex) | Elastic Modulus (GPa) |
| Example 1 - | 0 | 0 | 0 | 6.55 | 18.42 +/− 8.72 |
| Control | | | | | |
| Example 2 | − | 0 | ++ | 4.13 | 14.47 +/− 4.72 |
| Example 3 | − | − | + | 4.12 | 12.95 +/− 4.57 |
| Example 4 | −− | − | − | 4.4 | 8.60 +/− 3.27 |
| Example 5 | −− | −− | ++ | 4.73 | 8.33 +/− 3.63 |
| Example 6 | −− | −− | − | 5.11 | 11.55 +/− 4.43 |
| Example 7 | −− | 0 | ++ | 5.37 | 8.84 +/− 3.38 |
| Example 8 | − | 0 | ++ | 5.03 | 12.35 +/− 4.01 |
| Example 9 | −− | 0 | ++ | 5.78 | 11.74 +/− 4.83 |
| Example 10 | N/A | 0 | + | 4.98 | 14.44 +/− 7.15 |
| Example 11 | −− | 0 | ++ | 4.22 | 8.96 +/− 2.33 |

*“−” indicates some contamination, “−−” indicates even more contamination˜Protective coat Formulation 2I did not adhere to the active coat formulation surface.
**Samples are compared to the control. “−” indicates some fogging, a “−−” indicates much fogging. Fogging lowered the whiteness readings.
***Samples are compared to the control at time of failure. “−” is worse then the control, “+” is minimally better then the control, “++” is significantly better then the control
^{#}Values are given as change in b* value UV Ex from original reading after 4 hours in the QUV chamber

In Example 10, an “N/A” is listed for printhead contamination. The coating did not adhere sufficiently to enable testing and was considered to have failed the test.

The indicated elastic modulus values measure hardness of the coating. A higher value is desirable. UV additives generally impair the elastic modules values. The dimer material of Example 2 is seen to impair the value to a lesser extent. The measured 0.03 difference between Example 2 and Example 10 is considered significant. From a durability standpoint, any measurable improvement in elastic modulus is desirable.

Overall, Example 2 performs surprisingly better in terms of elastic modulus, retains more whiteness, performs well in the web rub test, has no measurable fogging and reduced printhead contamination as compared to the samples without the dimer material.

### Example 12

Thermally-Sensitive Color Forming Composition

| | |
|---|---|
| 50% | 2′-Anilino-6′-(N-ethyl-N-p-tolylamino)-3′-methylfluoran |
| 30% | 1-2-Diphenoxyethane |
| 16% | Carboxylated styrene/butadiene polymer |
| 2% | polyvinyl alcohol |
| 2% | Hydroxypropyl methyl-cellulose |

Protective Coat

| | |
|---|---|
| 20% | Polyvinyl alcohol |
| 9% | Polyamide epichlorohydrin crosslinker |
| 4% | Zinc stearate |
| 5% | 2,2′-methylenebis(6-(2H-benzotriazol-2-yl)-4- |
| | (1,1,3,3-tetramethylbutyl)phenol) |

Dispersion of each of the thermally sensitive colorforming compositions and of the protective coat is prepared. The dispersions are coated onto a paper or film substrate at a coat weight for each of about 3 gsm.

What is claimed is:

1. A heat-sensitive recording material comprising a substrate having coated thereon a thermally-sensitive color-forming composition in one or more layers, the thermally sensitive color forming composition comprising a chromogenic dye precursor, an acidic developer material and a first binder material, and at least one protective layer comprising 2,2′-methylenebis(6-(2H-benzotriazol-2-yl)-4-(1,1,3,3-tetramethylbutyl)phenol) dispersed in a second binder material, wherein the first binder material and the second binder material can be the same or different.

2. The heat sensitive recording material according to claim 1 wherein the 2,2′-methylenebis(6-(2H-benzotriazol-2-yl)-4-(1,1,3,3-tetramethylbutyl)phenol) is at from 0.1 to 75 weight percent based on weight of the protective layer.

3. The heat sensitive recording material according to claim 1 wherein the thermally sensitive color forming composition includes in addition bis(3-allyl-4-hydroxyphenyl)sulfone.

4. The heat sensitive recording material according to claim 1 wherein the bis(3-allyl-4-hydroxyphenyl)sulfone is at from 5 weight percent to 75 weight percent based on weight of the thermally sensitive color forming composition.

5. The heat sensitive recording material according to claim 1 wherein the thermally sensitive color forming composition in addition includes a sensitizer.

6. The heat sensitive recording material according to claim 5 wherein the sensitizer is selected from 1,2-diphenoxyethane, acetoacet-o-toluidine, dimethyl terephthalate, p-benzylbiphenyl, phenyl-1-hydroxy-2-naphthoate.

7. The heat sensitive recording material according to claim 1 wherein the 2,2′-methylenebis(6-(2H-benzotriazol-2-yl)-4-(1,1,3,3-tetramethylbutyl)phenol) is dispersed in a polymeric binder coated over the layer of thermally sensitive color forming composition.

8. The heat sensitive recording material according to claim 1 wherein the 2,2′-methylenebis(6-(2H-benzotriazol-2-yl)-4-(1,1,3,3-tetramethylbutyl)phenol) in addition is an additive in the thermally sensitive color forming composition.

9. The heat sensitive recording material according to claim 1 wherein the first and second binder materials are each independently selected from polyvinyl alcohol, polyvinyl acetate and polyacrylate.

10. The heat sensitive recording material according to claim 1 wherein the protective layer of 2,2′-methylenebis(6-(2H-benzotriazol-2-yl)-4-(1,1,3,3-tetramethylbutyl)phenol) dispersed in polymeric binder has a mean elastic modulus of at least 14.46 GPa.

11. The heat sensitive record material according to claim 10 wherein the record material has a whiteness value, measured by a Technidyne Color Touch 2-Model ISO Δb* following UV irradiation of four hours, of less than 4.2.

12. The heat sensitive record material according to claim 1 wherein the elastic modulus of the protective layer in at least 14 and the change in whiteness value Δb* following UV exposure for four hours, measured by a Technidyne Color Touch 2-Model ISO of less than 4.2.

13. A heat-sensitive recording material comprising a substrate having coated thereon a thermally-sensitive color-forming composition in one or more layers, the thermally sensitive color forming composition comprising a chromogenic dye precursor, an acidic developer material, a dimer material of the structure 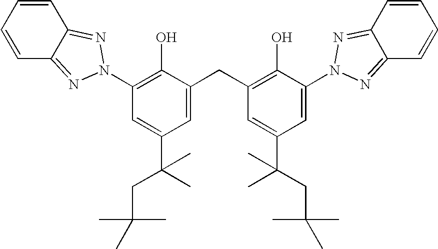
and a first binder material.

14. The heat sensitive recording material according to claim 13 wherein the 2,2′-methylenebis(6-(2H-benzotriazol-2-yl)-4-(1,1,3,3-tetramethylbutyl)phenol) is at from 0.1 to 40 weight percent based on weight of the protective layer.

15. The heat sensitive recording material according to claim 13 wherein the thermally sensitive color forming composition includes in addition bis(3-allyl-4-hydroxyphenyl)sulfone.

16. The heat sensitive recording material according to claim 13 wherein the bis(3-allyl-4-hydroxyphenyl)sulfone is at from 0.1 weight percent to 80 weight percent based on weight of the thermally sensitive color forming composition.

17. The heat sensitive recording material according to claim 13 wherein the thermally sensitive color forming composition in addition includes a sensitizer.

18. The heat sensitive record material according to claim 13 wherein the elastic modulus of the protective layer is at least 14 GPa and the whiteness value Δb* following UV exposure for four hours, measured by a Technidyne Color Touch 2-Model ISO is less than 4.2.

19. The heat sensitive recording material according to claim 13 wherein the 2,2′-methylenebis(6-(2H-benzotriazol-2-yl)-4-(1,1,3,3-tetramethylbutyl)phenol) is dispersed in a second binder material coated over the layer of thermally sensitive color forming composition.

20. The heat sensitive recording material according to claim 19 wherein the 2,2′-methylenebis(6-(2H-benzotriazol-2-yl)-4-(1,1,3,3-tetramethylbutyl)phenol) in addition is an additive in the thermally sensitive color forming composition.

21. The heat sensitive recording material according to claim 19 wherein the first and second binder materials are each independently selected from polyvinyl alcohol, polyvinyl acetate and polyacrylate.

22. The heat sensitive recording material according to claim 19 wherein the protective layer of 2,2′-methylenebis(6-(2H-benzotriazol-2-yl)-4-(1,1,3,3-tetramethylbutyl)phenol) dispersed in polymeric binder has a mean elastic modulus of at least 14.46 GPa.

23. The heat sensitive record material according to claim 19 wherein the record material has a whiteness value Δb* measured by a Technidyne Color Touch 2-Model ISO following UV exposure of four hours, of less than 4.2.
